(19) United States
(12) Patent Application Publication
(10) Pub. No.: US 2014/0210362 A1
(43) Pub. Date: Jul. 31, 2014

(54) ILLUMINATING APPARATUS USING SEMICONDUCTOR LIGHT EMITTING ELEMENTS

(71) Applicant: WOOREE LIGHTING CO., LTD., Gyeonggi-do (KR)

(72) Inventors: Sang Hyun Shin, Gyeonggi-do (KR); Dae Yun Jung, Gyeonggi-do (KR)

(73) Assignee: WOOREE LIGHTING CO., LTD., Gyeonggi-do (KR)

(21) Appl. No.: 14/166,953

(22) Filed: Jan. 29, 2014

(30) Foreign Application Priority Data
Jan. 30, 2013 (KR) 10-2013-0010404

(51) Int. Cl. H05B 33/08

(52) U.S. Cl. CPC H05B 33/083
USPC 315/186

(57) ABSTRACT

An illuminating apparatus using semiconductor light emitting elements comprising: n LED groups (n≧2) which are serially connected, each being capable of radiating light in a half cycle of an AC input voltage and including a first LED of a first color temperature or a second LED of a second color temperature higher than the first color temperature, wherein, in a current flow path, a first LED group of the n LED groups includes the first LED; and a set of switches including at least one bypass switch located between the p-th LED group (1≦p<n) and the (p+1)-th LED group in the current flow path for bypassing, in the ON position, a current flow to the (p+1)-th LED group, thereby enabling each of the n LED groups to radiate light in a certain interval of said half cycle.

### CROSS-REFERENCE TO RELATED APPLICATIONS

This application claims the benefit and priority of Korean Patent Application No. 10-2013-0010404, filed Jan. 30, 2013. The entire disclosure of the above application is incorporated herein by reference.

### FIELD

The present disclosure relates generally to an illuminating apparatus using semiconductor light emitting elements, and more particularly to an AC-driven illuminating apparatus using semiconductor light emitting elements.

### BACKGROUND

This section provides background information related to the present disclosure which is not necessarily prior art.

FIG. 1 is a view illustrating an example of a conventional semiconductor LED lighting apparatus using AC power, which includes an AC power source 100, a resistor 110 for regulating the voltage from the AC power source 100, and parallely connected LEDs 120 and 130 of opposite polarity. When a positive current flows, the LED 120 emits light; when a negative current flow, the LED 130 emits light.

FIG. 2 is a view illustrating another example of a conventional semiconductor LED lighting apparatus using AC power, in which a light emitting apparatus 200 includes a rectifier 210, a regulator 220 and a light emitting part 230. An alternating current is converted to a pulsating current through the rectifier 210 and then a direct current through the regulator 220 before it is fed to the light emitting part 230.

FIG. 3 is a view illustrating yet another example of a conventional semiconductor LED lighting apparatus using AC power, which includes a switching mode power supply 320 (SMPS) having a transformer, an LED array 330 formed of a plurality of serially connected light emitting diodes. When the SMPS 320 is used, however, an electromagnetic interference 350 (EMI) is additionally required.

FIG. 4 is a view illustrating yet another example of a conventional semiconductor LED lighting apparatus using AC power, which has a waveform as depicted in FIG. 5. Here, a light emitting device 400 includes a rectifier 410, and a plurality of serially connected LEDs 420 adapted to an input voltage. After the voltage goes through the rectifier 410, its waveform changes to one as shown in FIG. 5. The plurality of LEDs 420 is turned on or radiates light only after the voltage reaches a Tₒᵥ where all of the LEDs can be in a conductive state, and their lights go out when the voltage falls below Tₒᵥ (e.g. Tₒφφ). Therefore, although such a simplified configuration for the circuitry can be advantageous, there is a problem that the device cannot take an advantage of the full cycles of AC power.

FIG. 6 and FIG. 7 illustrate an example of a semiconductor LED lighting apparatus using AC power, as suggested in U.S. published patent application No. 2010-0194298. To resolve the problem mentioned above, a light emitting device 600 includes a rectifier 610, a controller 620 for controlling serially connected LEDs by dividing them into a plurality of groups 631, 632, 633, 634 and 634. The controller 620 has switches Q1, Q2, Q3, Q4, Q5 and Q6, controlling the light radiation of the groups 631, 632, 633, 634 and 635, respectively. When the rectified current voltage reaches a time T₁ and a voltage of 20V where the LED group 631 can be turned on, the switch Q1 remains in the ON position such that the current flowing through the LED group 631 is conducted with the switch Q1, and the LED group 631 radiates light at a voltage between 20V and 40V. At a time T2 and a voltage of 40V where the LED group 631 and the LED group 632 can be turned on, the switch Q1 is put in its OFF position while the switch Q2 remains in its ON position such that the current flowing through the LED group 631 and the LED group 632 is conducted with the switch Q1, and the LED group 631 radiates light at a voltage between 40V and 60V. In a similar way, the other LED groups up to the LED group 635 are lit up. Meanwhile, when a voltage is lowered, the LED group lights are dimmed down in sequence by turning the switches to the ON/OFF position. Even though the light emitting device of this example takes an advantage of using all of the rectified current for light radiation by LED groups, it has a problem that LED properties can change by time because while the LED group 631 radiates light across the full cycle, the LED group 635 radiates light only in an interval of the highest voltage.

### SUMMARY

The problems to be solved by the present disclosure will be described in the latter part of the best mode for carrying out the invention.

This section provides a general summary of the disclosure and is not a comprehensive disclosure of its full scope or all of its features.

According to an aspect of the present disclosure, there is provided an illuminating apparatus using semiconductor light emitting elements of which the brightness is controlled by a dimmer comprising: n LED groups (n≧2) which are serially connected, each being capable of radiating light in a half cycle of an AC input voltage and including a first LED of a first color temperature or a second LED of a second color temperature higher than the first color temperature, wherein, in a current flow path, a first LED group of the n LED groups includes the first LED; and a set of switches including at least one bypass switch located between the p-th LED group (1≦p<n) and the (p+1)-th LED group in the current flow path for bypassing, in the ON position, a current flow to the (p+1)-th LED group, thereby enabling each of the n LED groups to radiate light in a certain interval of said half cycle

The advantageous effects of the present disclosure will be described in the latter part of the best mode for carrying out the invention.

### DESCRIPTION OF DRAWINGS

FIG. 1 is a view illustrating an example of a conventional semiconductor LED lighting apparatus using AC power.

FIG. 2 is a view illustrating another example of a conventional semiconductor LED lighting apparatus using AC power.

FIG. 3 is a view illustrating yet another example of a conventional semiconductor LED lighting apparatus using AC power.

FIG. 4 and FIG. 5 illustrate yet another example of a conventional semiconductor LED lighting apparatus using AC power and a voltage waveform thereof.

FIG. 6 and FIG. 7 illustrate an example of a semiconductor LED lighting apparatus using AC power, as suggested in US published patent application No. 2010-0194298.

FIG. 8 is a view illustrating an example of an illuminating apparatus using semiconductor light emitting elements according to the present disclosure.

FIG. 9 is a graph showing an ON/OFF state in each interval depending on an input voltage to an illuminating apparatus using semiconductor light emitting elements according to the present disclosure.

FIG. 10 is a view illustrating an example of an LED array configuration for an illuminating apparatus using semiconductor light emitting elements according to the present disclosure.

FIG. 11 is a view illustrating another example of an LED array configuration for an illuminating apparatus using semiconductor light emitting elements according to the present disclosure.

FIG. 12 is a view illustrating yet another example of an LED array configuration for an illuminating apparatus using semiconductor light emitting elements according to the present disclosure.

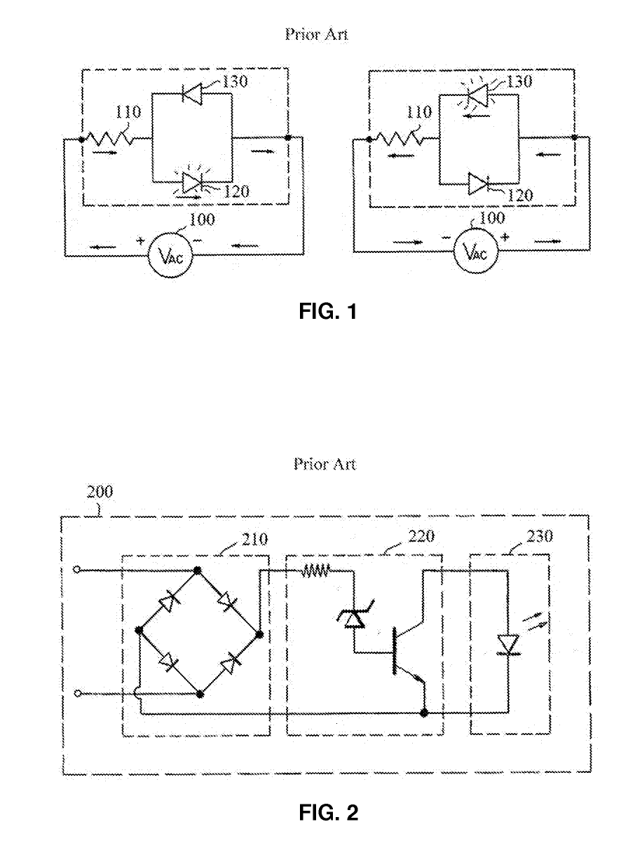

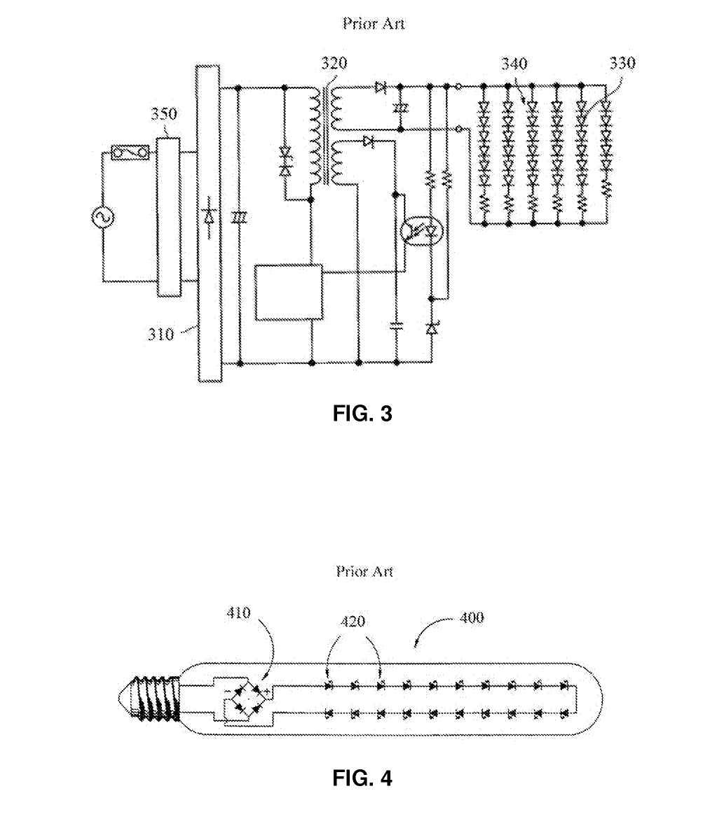

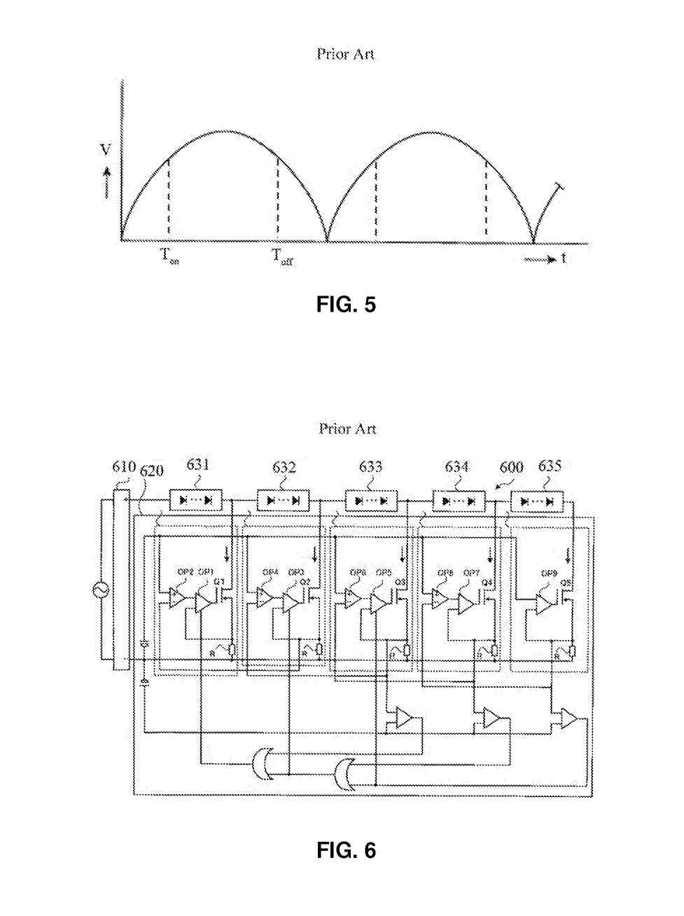

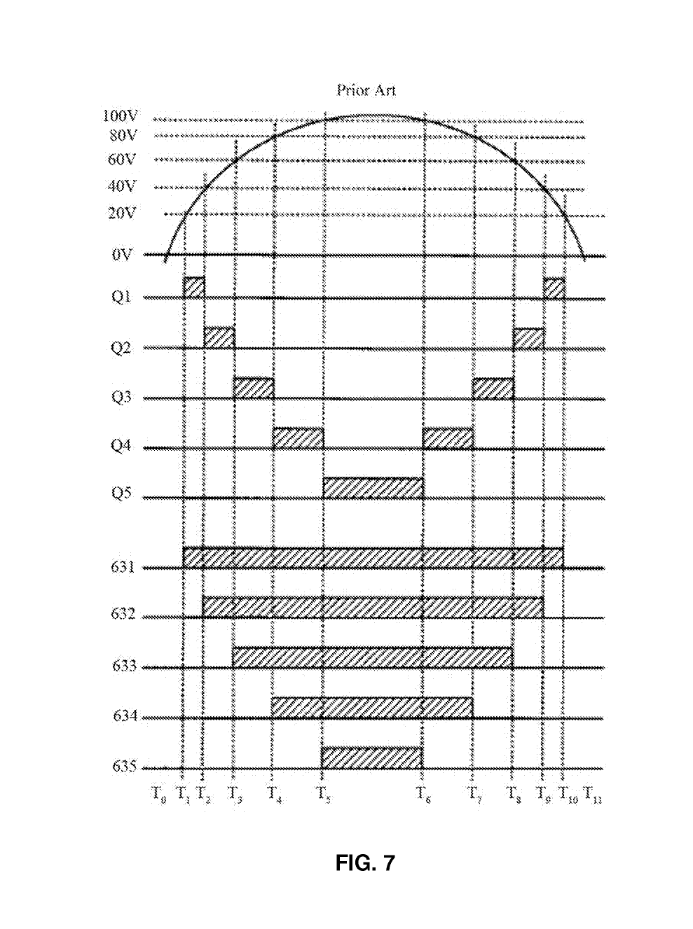

### DETAILED DESCRIPTION

Hereinafter, the present disclosure will now be described in detail with reference to the accompanying drawings.

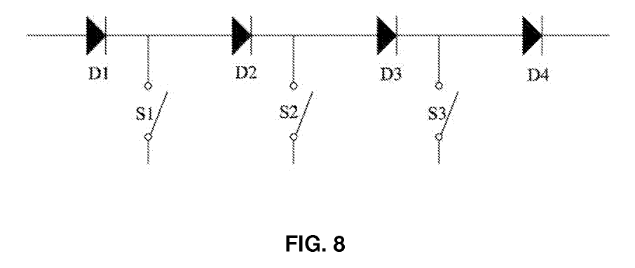

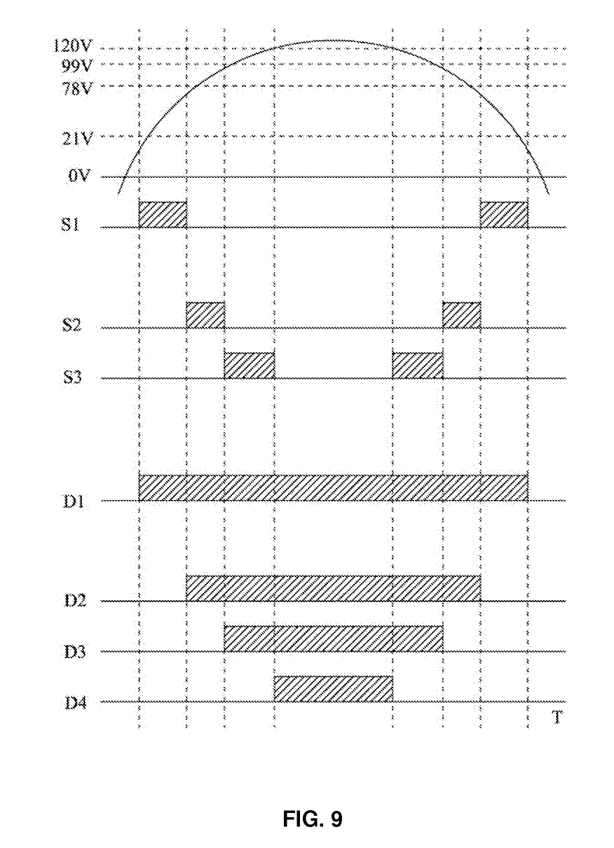

FIG. 8 is a view illustrating an example of an illuminating apparatus using semiconductor light emitting elements according to the present disclosure, and FIG. 9 is a graph showing an ON/OFF state in each interval depending on an input voltage to an illuminating apparatus using semiconductor light emitting elements according to the present disclosure.

An illuminating apparatus using semiconductor light emitting elements includes a plurality of LED groups D1, D2, D3 and D3, and one or more bypass switches S11, S12 and S13. The brightness of the illuminating apparatus using semiconductor light emitting elements can be controlled by a dimmer.

The dimmer can be provided by controlling the conduction time using, for example, a triac, or by incorporating a pulse width modulation method.

Each LED group D1, D2, D3 and D4 can radiate light in a half cycle of the AC voltage, and the LED groups are connected in series. Each LED group D1, D2, D3 and D4 has one or more LEDS, and those LEDs in the respective LED groups D1, D2, D3 and D4 are also connected in series.

The number of LED groups can vary, and the number of bypass switches S11, S12 and S13 can also vary depending on the number of the LED groups D1, D2, D3 and D4. The number of bypass switches S11, S12 and S13 to be provided is preferably less than the number of LED groups D1, D2, D3 and D4 by one.

For instance, when the number of LED groups D1, D2, D3 and D4 is equal to 4, bypass switches S11, S12 and S13 are positioned, in the current flow path, between the first LED group D1 and the second LED group D2, between the second LED group D2 and the third LED group D3, and between the third LED group D3 and the fourth LED group D4, respectively, illuminating each of the LED groups D1, D2, D3 and D4 in a certain interval of the half cycle.

The total number of LEDs constituting a semiconductor light emitting element illuminating apparatus is determined in consideration of the overall operating voltage as well as an inherent operating voltage of each LED. By way of example, in order to make a semiconductor light emitting element illuminating apparatus having the overall operating voltage of 120V by using yellow LEDs, each LED having an inherent operating voltage of about 2.6V, a total of 46 LEDs will be employed. These 46 LEDs can be divided into four LED groups D1, D2, D3 and D4. LEDs mentioned herein can be in a chip form or in an LED package form.

The LEDs in the plurality of LED groups D1, D2, D3 and D4 can include at least two types of LEDs of different color temperatures. For example, these LED groups may have two types of LED, one of the red or yellow LEDs of low color temperature, and the other of the green or blue LEDs of high color temperature. Moreover, LED groups may have three types of LED, one of the red or yellow LEDs of low color temperature, a green LED having a color temperature higher than that of the red LED and the yellow LED, and a blue LED having a color temperature higher than that of the green LED. Naturally, other diverse combinations of LEDs can also be used.

For instance, suppose that four LED groups D1, D2, D3 and D4 are available, and that they have two types of LEDs. Then, in the current flow path, the first LED group D1 may have LEDs of low color temperature, and the other LED groups D2, D3 and D4 may have LEDs of high color temperature. Needless to say, it is also possible that, in the current flow path, the first and second LED groups D1 and D2 may have LEDs of low color temperature, and the third and fourth LED groups D3 and D4 may have LEDs of high color temperature.

Therefore, when the LED group located upstream of the current flow path has LEDs of low color temperature, the quantity of light decreases in reverse order from the last fourth LED group by a dimming operation of the dimmer, and the LED groups are eventually turned off. In this process, the overall color temperature of the illuminating apparatus using semiconductor light emitting elements is gradually lowered. As such, a feeling of relatively coolness can be provided at the maximum brightness level, while a feeling of relatively warmth can be provided as the brightness level goes down. That is, the semiconductor light emitting part illuminating apparatus incorporating a dimmer can achieve dimming and variations of color temperature at the same time.

Meanwhile, suppose that four LED groups D1, D2, D3 and D4 are available, and that they have three types of LEDs. Then, in the current flow path, the first LED group D1 may have LEDs of low color temperature, the second LED group D2 may have LEDs of intermediate color temperature, and the third and fourth LED groups D3 and D4 may have LEDs of high color temperature. Needless to say, it is also possible to form the first and second LED groups D1 and D2 with LEDs of low color temperature, the third LED group D3 with LEDs of intermediate color temperature, and the fourth LED group D4 with LEDs of high color temperature. With this configuration, the apparatus can achieve variations of the color temperature that are accompanied with a dimming operation, in an even more gradual and natural way.

Furthermore, it is also conceivable to form four LED groups D1, D2, D3 and D4 with two types of LEDs, provided one LED group includes all of them. That is, along the current flow path, the first LED group D1 may have LEDs of low color temperature. The second and third LED groups D2 and D3 may have LEDs of both low and high color temperatures, provided the second LED group has a greater portion of LEDs of low color temperature than the third LED group. The fourth LED group D4 may have LEDs of high color temperature. Again, the apparatus with this configuration can achieve variations of the color temperature that are accompanied with a dimming operation, in an even more gradual and natural way.

The plurality of LED groups D1, D2, D3 and D4 can be divided into an LED group having a first group unit operating voltage, and an LED group having a second group unit operating voltage higher than the first group unit operating voltage. In addition, the plurality of LED groups D1, D2, D3 and D4 can be divided into an LED group having a second group unit operating voltage, and the other LED groups having a first group unit operating voltage. The first LED group in the current flow path preferably has a first group unit operating voltage. Naturally, when only two LED groups are available it is inevitable that the second LED group D2 in the current flow path corresponds to the last LED group, but when more than three LED groups are available the LED group having a second group unit operating voltage is preferably one of the remaining LED groups except the first LED group and the last LED group. Also, the second LED group is preferred to have a second group unit operating voltage than those of the other LED groups. Further, the second group unit operating voltage preferably ranges from twice to three times the first group unit operating voltage.

For example, as shown in FIG. 8, when a total of 46 LEDs are divided into four LED groups D1, D2, D3 and D4, the first LED group D1, the third LED group D3 and the fourth LED group D4 can each include 8 LEDs having a first group unit operating voltage of about 21V, and the second LED group D2 can include 22 LEDs having a second group unit operating voltage of about 57V. The number of LEDs constituting each of the LED groups D1, D2, D3 and D4 may vary within a range that satisfies the prerequisites described above. It should be noted that the LED groups D1, D3 and D4 having a first group unit operating voltage would not necessarily have the same number of LEDs, and a small variation in the number is allowed within the limits where they have a group unit operating voltage not higher than that of the first LED group D1.

Referring now to FIG. 9, when an AC input voltage in a sine wave form that is half-wave rectified through a rectifier is applied to four LED groups D1, D2, D3 and D4, light is radiated sequentially in the current flow path, starting from the first LED group D1 until it reaches the fourth LED group located downstream of the current flow path. In a half-cycle of the AC voltage, when the first LED group D1 reaches its group unit operating voltage, i.e. 21V, the bypass switch S1 remains in the ON position, and only the first LED group D1 is lit up. As the first LED group D1 has a low operating voltage as low as 21V, lighting of the illuminating apparatus using semiconductor light emitting elements starts at a low voltage. When the AC voltage reaches 78V, i.e. the sum of the first group unit operating voltage of the first LED group D1 and the second group unit operating voltage of the second LED group D1, the bypass switch S1 is turned to to the OFF position and at the same time the bypass switch S2 remains in the ON position, thereby the first LED group D1 and the second LED group D2 being lit up. When the AC voltage reaches 99V, i.e. the sum of the first to third group unit operating voltages of the first to third LED groups D1-D3, the bypass switch S2 is turned to the OFF position and at the same time the bypass switch S3 remains in the ON position, thereby the first LED group D1, the second LED group D2 and the third LED group D3 being lit up. Next, when the AC voltage reaches 120V, i.e. the sum of the first to fourth group unit operating voltages of the first to fourth LED groups D1-D4, the bypass switch S3 is turned to the OFF position, thereby all of the first to fourth LED groups D1, D2, D3 and D4 being lit up.

As mentioned above, when the first LED group D1 has a low group unit operating voltage, the start-up voltage for turning on the light during a dimming operation by the dimmer is set low such that a broader dimming range can be achieved. This enables a substantial improvement in the power efficiency and the power factor.

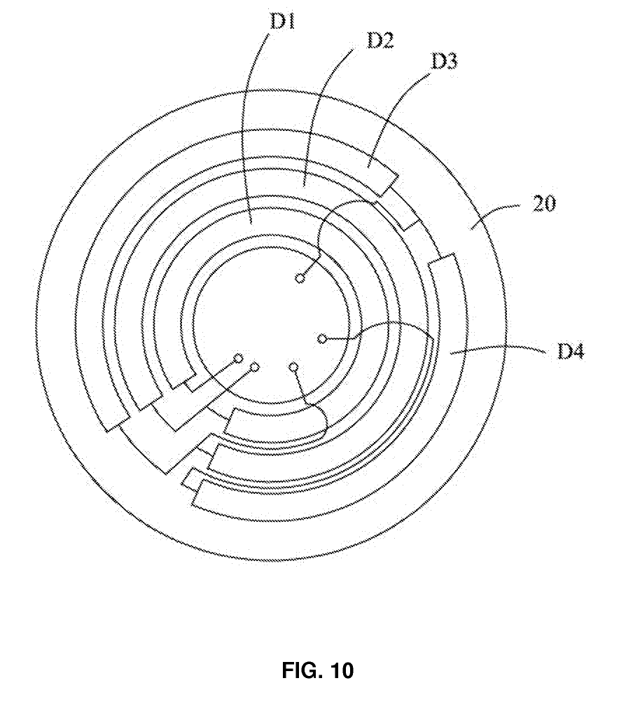

FIG. 10 is a view illustrating an example of an LED array configuration for an illuminating apparatus using semiconductor light emitting elements according to the present disclosure.

A plurality of LED groups D1, D2, D3 and D4 constituting the illuminating apparatus using semiconductor light emitting elements is mounted on a substrate 20 and forms a module. Preferably, the plurality of LED groups D1, D2, D3 and D4 is arranged on the substrate 20 in a layered structure, surrounding one after another from the center towards the edge of the substrate. Moreover, in the current flow path, the first LED group D1 preferably is arranged first, and then the others are arranged one after another in consecutive order in a radially outward direction from the center towards the edge of the substrate 20. With this layout, in a half cycle of the AC voltage, the first LED group D1 located upstream of the current flow path is first lit up, and then the fourth LED group D4 located downstream of the current flow path is lit up at the end.

Therefore, the lighting process gradually proceeds in the direction from the center towards the edge, while the light-out process gradually proceeds in the direction from the edge towards the center, thereby providing uniform lighting action all over. In contrast, the first LED group D1 in the current flow path can also be arranged at the edge of the substrate 20, and the others are then arranged one after another towards the center. In this case, the lighting process gradually proceeds in the direction from the edge towards the center of the substrate 20, while the light-out process gradually proceeds in the direction from the center towards the edge of the substrate 20, thereby providing uniform brightness all over.

As shown in FIG. 10, the substrate 20 can be in a circular form, and the LED groups D1, D2, D3 and D4 can be arranged concentrically on the substrate 20.

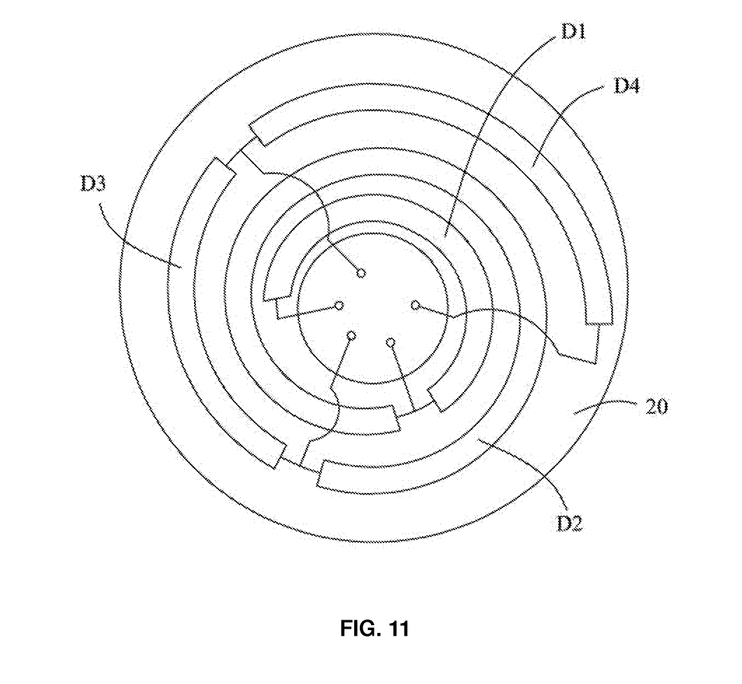

FIG. 11 is a view illustrating another example of an LED array configuration for an illuminating apparatus using semiconductor light emitting elements according to the present disclosure. This example is similar to one in FIG. 9 in that the substrate 20 can be in a circular form, but the LED groups D1, D2, D3 and D4 here are arranged in a spiral form.

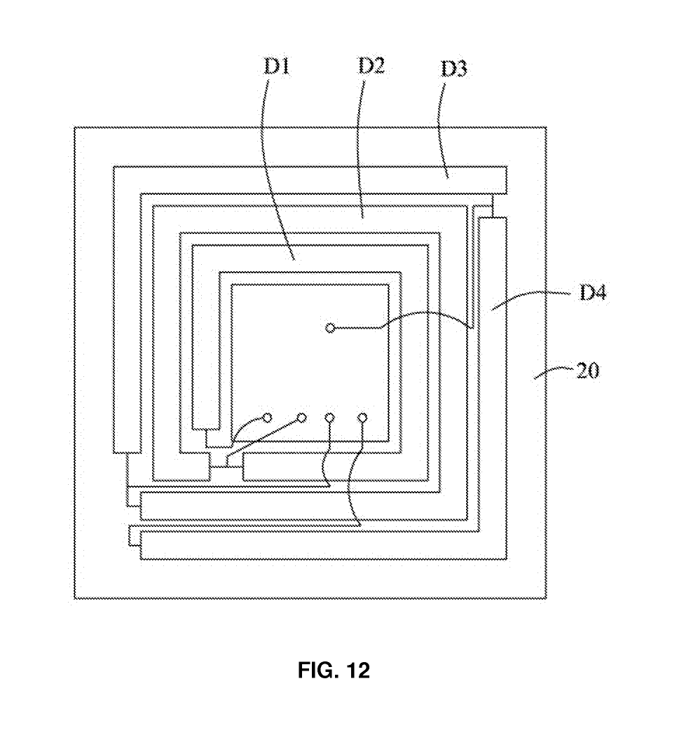

FIG. 12 is a view illustrating yet another example of an LED array configuration for an illuminating apparatus using semiconductor light emitting elements according to the present disclosure, in which the substrate 20 has a square form, and the LED groups D1, D2, D3 and D4 are arranged on the substrate 20 in a layered structure, surrounding one after another from the center towards the edge of the substrate.

To summarize, in the illuminating apparatus using semiconductor light emitting elements according to the present disclosure, a plurality of LED groups D1, D2, D3 and D4, each group having one or more LEDs, are serially connected in a balanced layout structure on the substrate. Bypass switches S1, S2 and S3 which are located between the LED groups to control the LED groups are lit up in consecutive order, thereby achieving uniform lighting action all over in any interval within the half cycle of an AC input voltage. Besides, even during a dimming operation by a dimmer, gradual brightness control can be provided from the center towards the edge, thereby achieving uniform lighting action all over without any dark area.

The following will now describe various embodiments of the present disclosure.

(1) an illuminating apparatus using semiconductor light emitting elements of which the brightness is controlled by a dimmer comprising: n LED groups (n≧2) which are serially connected, each being capable of radiating light in a half cycle of an AC input voltage and including a first LED of a first color temperature or a second LED of a second color temperature higher than the first color temperature, wherein, in a current flow path, a first LED group of the n LED groups includes the first LED; and a set of switches including at least one bypass switch located between the p-th LED group (1≦p<n) and the (p+1)-th LED group in the current flow path for bypassing, in the ON position, a current flow to the (p+1)-th LED group, thereby enabling each of the n LED groups to radiate light in a certain interval of said half cycle. For example, a half-cycle can be divided into (2n+1) intervals, and one LED group can radiate light in the 2nd interval. Likewise, k LED groups can radiate light in the (k+1)-th interval (1<k=n), and n LED groups can radiate light in the (n+1)-th interval, and (n+1−m) LED groups can radiate light in the (n+m)-th interval (1<m=n). Although the semiconductor light emitting element illuminating apparatus according to the present disclosure can incorporate the dimmer in itself, in many cases the dimmer is designed as part of the switch provided in a building, and is therefore omitted in general. Here, LEDs may be present in the form of an LED chip or an LED package. Also, a plurality of LED chips may be present in the form of a chip on board (COB). Further, the color temperature can be adjusted by the LED chip itself, or by using an auxiliary material such as phosphor. A laser diode may be used as the semiconductor light emitting element.

(2) An illuminating apparatus using semiconductor light emitting elements, wherein n is at least 3, and one or more consecutive LED groups out of the LED groups from the first LED group in the current flow path comprise the first LED, and the other LED groups comprise the second LED.

(3) An illuminating apparatus using semiconductor light emitting elements, wherein n is at least 3, and one or more consecutive LED groups out of the LED groups from the 2nd LED group to the (n−1)-th LED group compose a third LED having a third color temperature higher than the first color temperature and lower than the second color temperature.

(4) An illuminating apparatus using semiconductor light emitting elements, wherein one or more consecutive LED groups out of the LED groups from the first LED group to the n-th LED group in the current flow path comprise the first LED and the second LED.

(5) An illuminating apparatus using semiconductor light emitting elements, wherein two or more LED groups comprise both the first LED and the second LED, and the LED groups from the upstream towards the downstream of the current flow path have an increasing portion of the second LEDs.

(6) An illuminating apparatus using semiconductor light emitting elements, wherein (n−1) LED groups including the first LED group out of n LED groups have a first operating voltage, and the other one LED group has a second operating voltage higher than the first operating voltage.

(7) An illuminating apparatus using semiconductor light emitting elements, wherein the second operating voltage ranges from twice to three times the first group unit operating voltage.

(8) An illuminating apparatus using semiconductor light emitting elements, wherein the 2nd LED group has the second operating voltage.

(9) An illuminating apparatus using semiconductor light emitting elements, wherein n is at least 3, and the LED group having the second operating voltage constitutes any one of the remaining LED groups except the first and n-th LED groups.

(10) An illuminating apparatus using semiconductor light emitting elements, wherein, in said half cycle, the LED groups radiate light in consecutive order, starting from the first LED group located upstream of the current flow path to the n-th LED group located downstream of the current flow path radiating light.

(11) An illuminating apparatus using semiconductor light emitting elements, wherein the apparatus further comprises a substrate, and the n LED groups are arranged on the substrate in a layered structure, surrounding one after another from the center towards the edge of the substrate.

(12) An illuminating apparatus using semiconductor light emitting elements, wherein the first LED group in the current flow path is arranged first at the center of the substrate, and then the other LED groups are arranged one after another towards the edge of the substrate.

(13) An illuminating apparatus using semiconductor light emitting elements, wherein the substrate is in a circular form, and the n LED groups are arranged concentrically on the substrate.

The present disclosure is directed to provide a semiconductor light emitting element illuminating apparatus that can be driven by AC and has the capabilities to control brightness and adjust color temperature.

In an illuminating apparatus using semiconductor light emitting elements according to the present disclosure, the first LED group has a low color temperature, which allows for adjustment of the color temperature during a dimming operation by the dimmer.

In another illuminating apparatus using semiconductor light emitting elements according to the present disclosure, the first LED group has a low group unit operating voltage, which allows to set the start-up voltage for turning on the light during a dimming operation by the dimmer low such that a broader dimming range can be achieved.

In yet another illuminating apparatus using semiconductor light emitting elements according to the present disclosure, a substantial improvement in the power efficiency and the power factor can be obtained.

In yet another illuminating apparatus using semiconductor light emitting elements according to the present disclosure, it is possible to achieve uniform lighting action all over in any interval within the half cycle of an AC input voltage.

In yet another illuminating apparatus using semiconductor light emitting elements according to the present disclosure, during a dimming operation by a dimmer, gradual brightness control can be provided from the center towards the edge such that it is possible to achieve uniform lighting action all over without any dark area.

What is claimed is:

1. An illuminating apparatus using semiconductor light emitting elements of which the brightness is controlled by a dimmer comprising: n LED groups (n≧2) which are serially connected, each being capable of radiating light in a half cycle of an AC input voltage and including a first LED of a first color temperature or a second LED of a second color temperature higher than the first color temperature, wherein, in a current flow path, a first LED group of the n LED groups includes the first LED; and a set of switches including at least one bypass switch located between the p-th LED group (1≦p<n) and the (p+1)-th LED group in the current flow path for bypassing, in the ON position, a current flow to the (p+1)-th LED group, thereby enabling each of the n LED groups to radiate light in a certain interval of said half cycle.

2. The illuminating apparatus using semiconductor light emitting elements as claimed in claim 1, wherein n is at least 3, and one or more consecutive LED groups out of the LED groups from the first LED group in the current flow path comprise the first LED, and the other LED groups comprise the second LED.

3. The illuminating apparatus using semiconductor light emitting elements as claimed in claim 1, wherein n is at least 3, and one or more consecutive LED groups out of the LED groups from the 2nd LED group to the (n−1)-th LED group compose a third LED having a third color temperature higher than the first color temperature and lower than the second color temperature.

4. The illuminating apparatus using semiconductor light emitting elements as claimed in claim 1, wherein one or more consecutive LED groups out of the LED groups from the first LED group to the n-th LED group in the current flow path comprise the first LED and the second LED.

5. The illuminating apparatus using semiconductor light emitting elements as claimed in claim 4, wherein two or more LED groups comprise both the first LED and the second LED, and the LED groups from the upstream towards the downstream of the current flow path have an increasing portion of the second LEDs.

6. The illuminating apparatus using semiconductor light emitting elements as claimed in claim 1, wherein (n−1) LED groups including the first LED group out of n LED groups have a first operating voltage, and the other one LED group has a second operating voltage higher than the first operating voltage.

7. The illuminating apparatus using semiconductor light emitting elements as claimed in claim 6, wherein the second operating voltage ranges from twice to three times the first group unit operating voltage.

8. The illuminating apparatus using semiconductor light emitting elements as claimed in claim 6, wherein the 2nd LED group has the second operating voltage.

9. The illuminating apparatus using semiconductor light emitting elements as claimed in claim 6, wherein n is at least 3, and the LED group having the second operating voltage constitutes any one of the remaining LED groups except the first and n-th LED groups.

10. The illuminating apparatus using semiconductor light emitting elements as claimed in claim 1, wherein, in said half cycle, the LED groups radiate light in consecutive order, starting from the first LED group located upstream of the current flow path to the n-th LED group located downstream of the current flow path radiating light.

11. The illuminating apparatus using semiconductor light emitting elements as claimed in claim 1, wherein the apparatus further comprises a substrate, and the n LED groups are arranged on the substrate in a layered structure, surrounding one after another from the center towards the edge of the substrate.

12. The illuminating apparatus using semiconductor light emitting elements as claimed in claim 11, wherein the first LED group in the current flow path is arranged first at the center of the substrate, and then the other LED groups are arranged one after another towards the edge of the substrate.

13. The illuminating apparatus using semiconductor light emitting elements as claimed in claim 11, wherein the substrate is in a circular form, and the n LED groups are arranged concentrically on the substrate.
